(19) United States
(12) Patent Application Publication
(10) Pub. No.: US 2009/0109588 A1
(43) Pub. Date: Apr. 30, 2009

(54) Load driver with wire break detection circuit

(75) Inventors: Tsutomu Hayama, Handa-city (JP); Satoshi Yoshimura, Kariya-city (JP); Tsutomu Yonei, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,578

(22) Filed: Oct. 9, 2008

(30) Foreign Application Priority Data
Oct. 30, 2007 (JP) 2007-281674
Jun. 10, 2008 (JP) 2008-151619

(51) Int. Cl. H02H 9/02

(52) U.S. Cl. 361/93.1

(57) ABSTRACT

A load driver includes a transistor coupled in series with a load, a control circuit for controlling the transistor, and a wire break detection circuit. The wire break detection circuit includes a current detection device and a wire break detection device. The current detection device is coupled between a first point in a wire connecting the control circuit to a ground terminal and a second point in a path through which a load current flows. The wire break detection device determines that a break occurs in the wire, when the current detection device detects an electric current flowing from the first point to the second point.

### CROSS REFERENCE TO RELATED APPLICATION

This application is based on and incorporates herein by reference Japanese Patent Applications No. 2007-281674 filed on Oct. 30, 2007 and No. 2008-151619 filed on Jun. 10, 2008.

### FIELD OF THE INVENTION

The present invention relates to a load driver with a wire break detection circuit configured to detect a break in a wire that provides a reference potential to the load driver.

### BACKGROUND OF THE INVENTION

An internal combustion engine includes a catalyst that is disposed in its exhaust gas passage to clean exhaust gas. However, the catalysts may not be capable of sufficiently cleaning the exhaust gas, when a temperature of the exhaust gas is not sufficiently high during, for example, the cold start of the internal combustion engine.

FIG. 6 illustrates a conventional secondary air injection system 9 disclosed in, for example, U.S. Pat. No. 7,100,368 corresponding to JP-A-2005-307957. In the secondary air injection system 9, secondary air is injected into the exhaust gas passage upstream of the catalyst by using an air pump and a switching valve. Thus, the concentration of oxygen in the exhaust gas is increased, and accordingly the air-fuel ratio of the exhaust gas is increased. As a result, secondary combustion such as of HC and CO in the exhaust gas is promoted so that the exhaust gas can be cleaned. Further, since the temperature of the exhaust gas rises, the catalyst can be quickly activated.

Specifically, in the secondary air injection system 9, an air filter 3 is located on the upstream side of an intake pipe 2 of a multicylinder engine 1. A throttle valve 4 is located on the downstream side of the intake pipe 2 with respect to the air filter 3. A fuel injection valve (not shown) is located near an intake port of an intake manifold 5 of the engine 1. A catalyst 7 is placed in an exhaust pipe 6 of the engine 1 to clean the exhaust gas. An oxygen (O2) sensor 8 is placed on the upstream side of the exhaust pipe 6 with respect to the catalyst 7 and measures a concentration of oxygen in the exhaust gas.

A secondary air supply pipe 11 connects the upstream side of the intake pipe 2 with respect to the throttle valve 4 and the upstream side of the exhaust pipe 6 with respect to the O2 sensor 8. An air pump 12, an electromagnetic valve 13, and a check valve 14 are placed in the secondary air supply pipe 11 in the mentioned order from the upstream side of the secondary air supply pipe 11. The air pump 12 is driven by a motor 12a, and the electromagnetic valve 13 is driven by an electromagnetic coil 13a. A pressure sensor 15 is placed between the air pump 12 and the electromagnetic valve 13.

An air injection driver (AID) 16 drives the air pump 12 and the electromagnetic valve 13 in accordance with a command signal received from an engine electronic control unit (ECU) 17. The engine ECU 17 receives sensor signals from the O2 sensor 8 and the pressure sensor 15.

As shown in FIG. 7, which partly corresponds to FIG. 4 of U.S. Pat. No. 7,100,368, the air injection driver 16 receives electric power from a battery 18 of a vehicle through a fuse (not shown) and a relay (not shown) that is turned on and off by an ignition switch (not shown). The motor 12a for driving the air pump 12 receives electric power from the battery 18 through an N-channel power MOSFET 19 that is incorporated in the air injection driver 16. The electromagnetic coil 13a for driving the electromagnetic valve 13 receives electric power from the battery 18 through an N-channel power MOSFET 20 that is incorporated in the air injection driver 16.

The engine ECU 17 outputs a pump drive signal SIP and a valve drive signal SIV to the air injection driver 16. A control circuit 21 of the air injection driver 16 outputs the drive signals SIP, SIV to the MOSFETs 19, 20, respectively. Specifically, the sources of the MOSFETs 19, 20 are coupled to a positive terminal of the battery 18 via a power terminal BATT of the air injection driver 16. The drain of the MOSFET 19 is coupled to a positive terminal of the motor 12a via an output terminal VP of the air injection driver 16. The drain of the MOSFET 20 is coupled to a positive terminal of the electromagnetic coil 13a via an output terminal VV of the air injection driver 16. In this way, each of the MOSFETs 19, 20 is coupled in a so-called high-side drive configuration.

The gate of the MOSFET 19 is coupled through a resistor 22 to a ground terminal GND of the air injection driver 16. The ground terminal GND is coupled to a chassis earth E and used as a circuit ground of the air injection driver 16. A series circuit of an NPN transistor 23 and a diode 24 is coupled between the gate of the MOSFET 19 and the output terminal VP. The base of the transistor 23 is coupled to the ground terminal GND through a variable resistor 25.

When a break occurs in a ground wire connecting the ground terminal GND to the chassis earth E, an electric current flows into the base of the transistor 23 through the variable resistor 25. Since the electric current has a magnitude corresponding to a consumption current of the air injection driver 16 (e.g., a few tens of milliamperes), the transistor 23 is turned on. As a result, a gate potential of the MOSFET 19 with respect to a potential of the output terminal VP becomes the sum of a forward bias voltage VF of the diode 24 and a collector-to-emitter voltage VCE of the transistor 23. That is, a gate-to-source voltage of the MOSFET 19 becomes VF+VCE (e.g., about 0.7 volts), which is less than a threshold voltage VT (e.g., 2 volts) of the MOSFET 19. Therefore, when the break occurs in the ground wire, the MOSFET 19 is turned off so that the motor 12a can be stopped.

The present inventors conceive of the idea of causing the control circuit 21 of the air injection driver 16 to output a diagnosis signal to the engine ECU 17 in the event of the ground wire break, for example, by adding a diagnosis circuit 29 to the control circuit 21. As shown in FIG. 7, the diagnosis circuit 29 includes a resistor 26 and NPN transistors 27, 28. The resistor 26 and the transistor 27 are coupled in series between a diag output terminal DI and the ground terminal GND of the air injection driver 16. The transistor 28 is coupled between the collector and base of the transistor 27. That is, the transistors 27, 28 are coupled in a Darlington configuration. An electric current is continuously supplied to the base of the transistor 28 from a current source (not shown).

The diagnosis signal is outputted from the diagnosis circuit 29 to the engine ECU 17 in the following manner. When the break occurs in the ground wire, the transistor 23 is turned on, and the potential of the circuit ground rises. As a result, in the air injection driver 16, a gate signal is applied to the MOSFET 19 such that the MOSFET 19 can be turned on. Therefore, an electric current IP flows through a path indicated by a broken line in FIG. 7. As a result, the potential of the circuit ground becomes “Vvp+2VF+R1×IP”, where Vvp represents the potential of the output terminal VP, and R1 represents a resistance of the variable resistor 25.

In normal conditions, a voltage level of the diag output terminal DI with respect to the circuit ground is determined by the sum of a collector-to-emitter voltage VCE of the transistor 27 and a voltage drop across the resistor 26, through which a collector current of the transistor 27 flows. Since the potential of the circuit ground rises in the event of the ground wire break, the voltage level of the diag output terminal DI rises accordingly. In this way, the diagnosis circuit 29 outputs the diagnosis signal to the engine ECU 17 via the diag output terminal DI.

It is preferable that the voltage level of the diagnosis signal (i.e., diag output terminal DI) be uniform so that the wire break can be surely detected. As described above, the voltage level of the diagnosis signal depends on the magnitude of the electric current IP, which flows in the event of the wire break. The magnitude of the electric current IP changes, for example, when a circuit constant of the air injection driver 16 changes. In such a case, the magnitude of the electric current IP is corrected by adjusting the resistance R1 of the variable resistor 25 so that the voltage level of the diagnosis signal can be kept uniform However, the adjustment of the resistance R1 requires much time and trouble.

### SUMMARY OF THE INVENTION

In view of the above-described problem, it is an object of the present invention to provide a load driver having a wire detection circuit configured to surely detect a wire break in the load driver regardless of the magnitude of an electric current that flows in the event of the wire break.

According to an aspect of the present invention, a load driver for driving an electric load includes a transistor, a control circuit, and a wire break detection circuit. The transistor is coupled in series with the load between a power source and a first reference potential point. The control circuit turns on and off the transistor to control a first electric current that flows in a path between the power source and the first reference potential point through the load. The control circuit is coupled through a wire to a second reference potential point that provides a reference potential to the control circuit. The wire break detection circuit includes a current detection device and a wire break detection device. The current detection device is coupled between a first point in the wire and a second point in the path to detect a second electric current flowing between the first point and the second point. The wire break detection device determines that a break occurs in the wire, when the current detection device detects the second electric current. The control circuit and the second reference point are joined together at the first point. The second point is located on the first reference potential point side with respect to the transistor.

### BRIEF DESCRIPTION OF THE DRAWINGS

The above and other objectives, features and advantages of the present invention will become more apparent from the following detailed description made with check to the accompanying drawings. In the drawings:

FIG. 1 is a circuit diagram illustrating a load driver according to a first embodiment of the present invention;

FIG. 2 is a circuit diagram illustrating a load driver according to a second embodiment of the present invention;

FIG. 3 is a circuit diagram illustrating a load driver according to a third embodiment of the present invention;

FIG. 4 is a circuit diagram illustrating a load driver according to a fourth embodiment of the present invention;

FIG. 5 is a circuit diagram illustrating a load driver according to a fifth embodiment of the present invention;

FIG. 6 is a block diagram illustrating a prior-art secondary air injection system; and

FIG. 7 is a circuit diagram illustrating a related-art air injection driver.

### DETAILED DESCRIPTION OF THE PREFERRED EMBODIMENTS

### First Embodiment

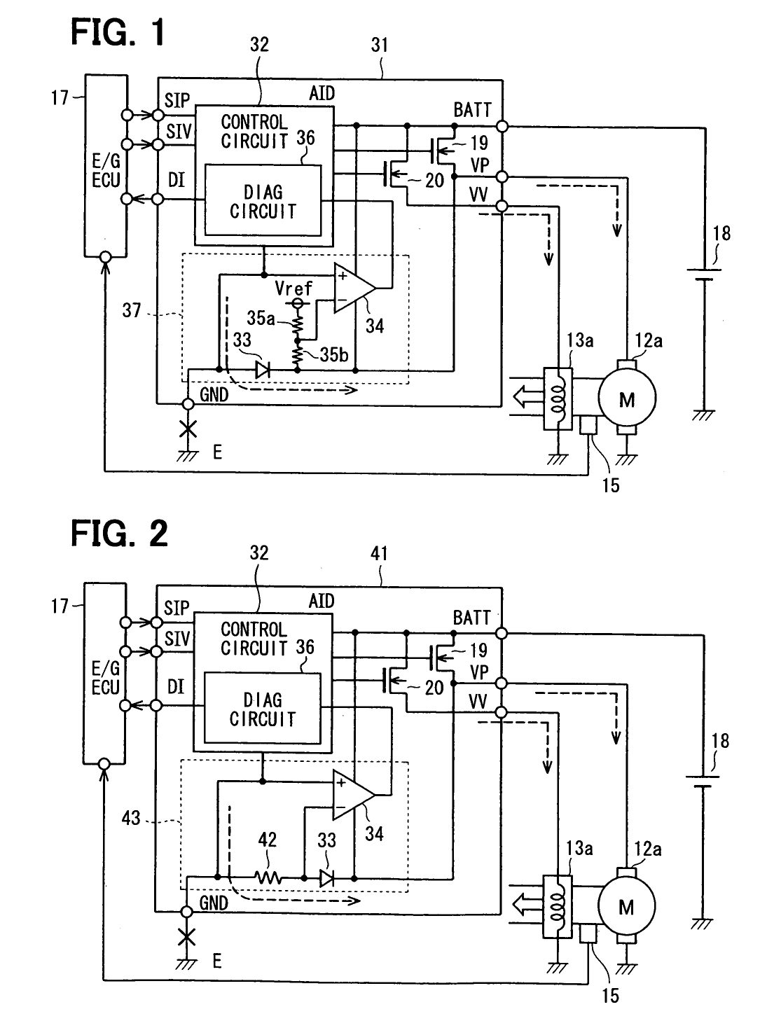

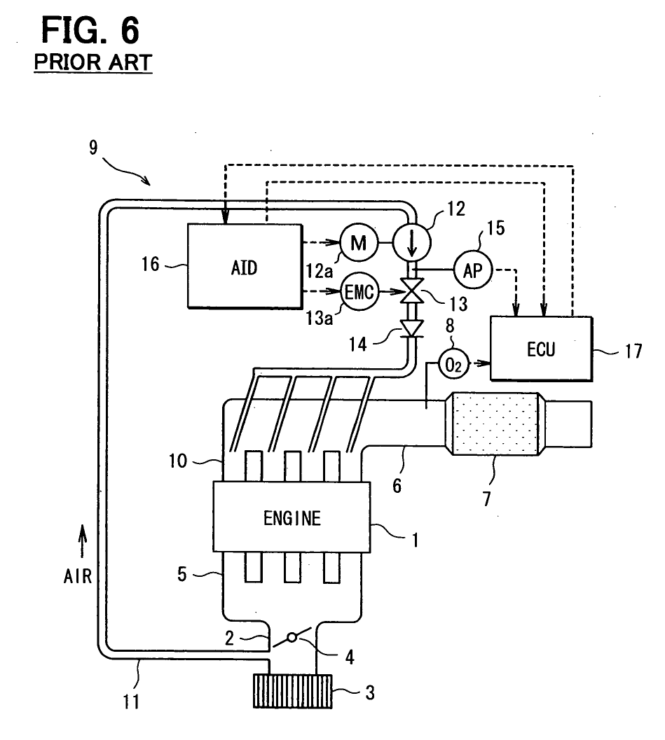

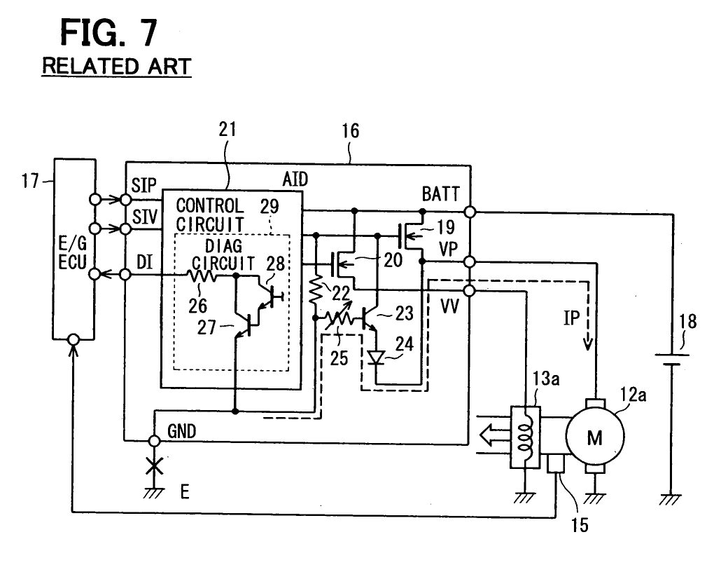

An air injection driver (AID) 31 according to a first embodiment of the present invention is illustrated in FIG. 1. The air injection driver 31 can be used in the secondary air injection system 9 illustrated in FIG. 6 instead of the air injection driver 16 illustrated in FIG. 7. Differences between the air injection drivers 16, 31 are described below with reference to FIGS. 1 and 7.

The air injection driver 31 does not have the resistors 22, 25, the transistor 23, and the diode 24. In the air injection driver 31, a diode 33 (current detection element) is coupled in a forward bias direction between an output terminal VP of the air injection driver 31 and a node between a control circuit 32 of the air injection driver 31 and a ground terminal GND (second reference potential) of the air injection driver 31. The ground terminal GND is coupled to a chassis earth E (reference potential) and used as a circuit ground of the control circuit 32. The anode of the diode 33 is coupled to a non-inverting input of a comparator 34 (wire break detection device). The cathode of the diode 33 is coupled to an inverting input of the comparator 34. A reference voltage Vref is divided by resistors 35a, 35b and then applied to the inverting input of the comparator 34. The resistor 35a is coupled to the reference voltage Vref at one end, and the resistor 35b is coupled to the cathode of the diode 33 at one end. For example, the reference voltage Vref can be from about 1 volt to about 5 volts.

An output of the comparator 34 is coupled to a diag output terminal DI of the air injection driver 31 through a diagnosis circuit 36 incorporated in the control circuit 32. The diagnosis circuit 36 is a driver circuit configured to output a diagnosis signal to an engine ECU 17. A ground terminal of the comparator 34 is coupled to the cathode of the diode 33. The diode 33 and the comparator 34 form a wire break detection circuit 37.

The air injection driver 31 according to the first embodiment operates in the following manner. In normal conditions where the ground terminal GND of the air injection driver 31 remains coupled to the chassis earth E, a potential of the anode of the diode 33 is less than a potential of the cathode of the diode 33. Therefore, the diode 33 is reverse-biased and kept in the “OFF” state.

Conversely, when a break occurs in a ground wire connecting the ground terminal GND to the chassis earth E, a consumption current of the air injection driver 31 flows to the output terminal VP through the diode 33 and then flows to a ground (first reference potential) through a motor 12a. Since the diode 33 is switched “ON”, the diode 33 generates a forward bias voltage VF. The forward bias voltage VF causes a potential of the non-inverting input of the comparator 34 to exceed a potential of the inverting input of the comparator 34. As a result, an output level of the comparator 34 changes from low to high. Accordingly, a voltage level of the diag output terminal DI changes, for example, from low to high. In this way, the break in the ground wire is detected based on the voltage level of the diag output terminal DI.

According to the first embodiment, the diode 33 is coupled between the drain of the MOSFET 19 and the ground terminal GND of the air injection driver 31. The comparator 34 determines that the break in the ground wire, when an electric current flows through the diode 33 by way of the control circuit 32. In such an approach, the wire break can be surely detected without keeping uniform the electric current flowing in the event of the wire break. Therefore, there is no need to perform a complicated adjustment to keep the electric current uniform.

The diode 33 prevents a reverse current flowing from the MOSFET 19 side. When the wire break occurs, the electric current flows through the diode 33, and the diode 33 generates the forward bias voltage VF. The comparator 34 determines whether the electric current flows through the diode 33 by detecting the forward bias voltage VF. Thus, the wire break can be easily detected based on the change in the output level of the comparator 34.

### Second Embodiment

FIG. 2 illustrates an air injection driver (AID) 41 according to a second embodiment of the present invention. Differences between the first and second embodiments are described below with reference to FIGS. 1 and 2.

The air injection driver 41 includes a resistor 42 used as a current detection element. The resistor 42 is coupled between the inverting and non-inverting inputs of the comparator 34 so that the comparator 34 can detect a voltage drop across the resistor 42. The diode 33 is coupled between the resistor 42 and the output terminal VP. Unlike the first embodiment, the reference voltage Vref is not applied to the inverting input of the comparator 34. The diode 33, the comparator 34, and the resistor 42 form a wire break detection circuit 43.

The air injection driver 41 according to the second embodiment operates in the following manner. In the air injection driver 41, the diode 33 is used only to prevent the reverse current flowing from the MOSFET 19 side. The electric current flowing in the event of the wire break is detected by the resistor 42.

Specifically, in the normal conditions where the wire break does not occur, an input bias current flowing out from the comparator 34 flows from the resistor 42 to the ground terminal GND. As a result, an input offset voltage occurs so that the output of the comparator 34 becomes low. Conversely, when the wire break occurs, the consumption of the air injection driver 41 flows to the output terminal VP side though the resistor 42.

Therefore, the voltage drop across the resistor 42 becomes a value determined by multiplying a resistance of the resistor 42 by the consumption current. As a result, the output of the comparator 34 changes from low to high so that the diagnosis circuit 36 can output the diagnosis signal to the engine ECU 17 through the diag output terminal DI.

As described above, according to the second embodiment, the wire break detection circuit 43 uses the resistor 42 instead of the diode 33 to detect the electric current flowing in the event of the wire break. Therefore, the second embodiment can have a similar effect to that of the first embodiment.

### Third Embodiment

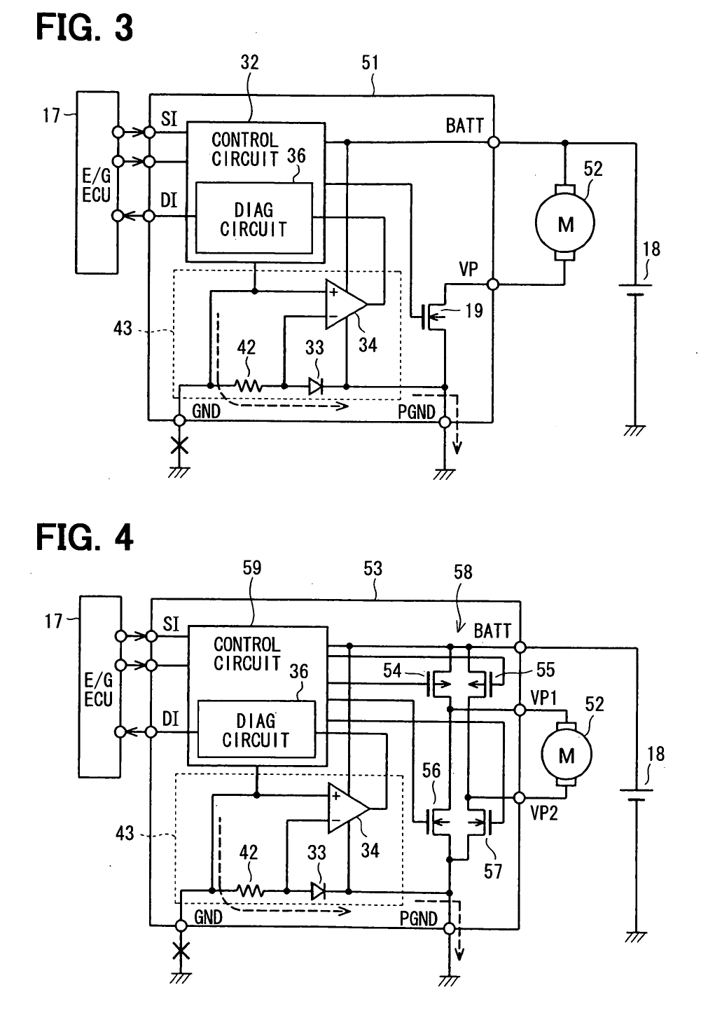

FIG. 3 illustrates a load driver 51 according to a third embodiment of the present invention. Differences between the second and third embodiments are described below with reference to FIGS. 2 and 3.

In the second embodiment, the MOSFET 19 is coupled to the motor 12a in a high-side drive configuration, and the motor 12a is configured to drive the air pump 12 shown in FIG. 6.

In the third embodiment, the MOSFET 19 is coupled to a motor 52 in a low-side drive configuration. The motor 52 is a typical DC motor and can be configured to drive an electronic load other than an air pump. The motor 52 is coupled between the positive terminal of the battery 18 and an output terminal VP of the load driver 51. The load driver 51 has a ground terminal PGND (first reference potential point) in addition to the ground terminal GND. The MOSFET 19 is coupled between the output terminal VP and the ground terminal PGND. Thus, in the load driver 51, a terminal for providing a ground potential to the source of the MOSFET 19 is separated from a terminal for providing a ground potential to the control circuit 32. The cathode of the diode 33 and the ground terminal of the comparator 34 are coupled to the ground terminal PGND. In a chassis earth, the ground terminal GND and the ground terminal PGND are respectively coupled to a control ground and a power ground that are physically separated from each other.

The load driver 51 according to the third embodiment operates in the following manner. In the normal condition where the wire break does not occur, an input bias current flowing out from the comparator 34 flows from the resistor 42 to the ground terminal GND. As a result, an input offset voltage occurs so that the output of the comparator 34 becomes low. Conversely, when the wire break occurs, a consumption of the load driver 51 flows to the ground terminal PGND though the resistor 42. Therefore, the voltage drop across the resistor 42 becomes a value determined by multiplying the resistance of the resistor 42 by the consumption current. As a result, the output of the comparator 34 changes from low to high so that the diagnosis circuit 36 can output the diagnosis signal to the engine ECU 17 through the diag output terminal DI. Thus, the third embodiment employing a low-side drive configuration can have a similar effect to that of the second embodiment employing a high-side drive configuration.

### Fourth Embodiment

FIG. 4 illustrates a load driver 53 according to a fourth embodiment of the present invention. Differences between the third and fourth embodiments are described below with reference to FIGS. 3 and 4.

The load driver 53 includes P-channel power MOSFETs 54, 55 and N-channel power MOSFETs 56, 57. The MOSFETs 54-57 are coupled to form a H-bridge (i.e., full bridge) circuit 58. The load driver 53 can drive the motor 52 both in forward and reverse directions using the H-bridge circuit 58. Specifically, the sources of the MOSFETs 54, 55 are coupled to a power terminal BATT of the load driver 53, and the sources of the MOSFETs 56, 57 are coupled to a ground terminal PGND of the load driver 53.

The drains of the MOSFETs 54, 56 are coupled to an output terminal VP1 of the load driver 53, and the drains of the MOSFETs 55, 57 are coupled to an output terminal VP2 of the load driver 53. The motor 52 is coupled between the output terminals VP1, VP2. For example, a control circuit 59 of the load driver 53 drives the motor 52 in a forward direction by turning on the MOSFETs 54, 57 and drives the motor 52 in a reverse direction by turning on the MOSFETs 55, 56.

When the break occurs in the ground wire connecting the ground terminal GND to the chassis earth E, a consumption of the load driver 53 flows to the ground terminal PGND though the resistor 42. Therefore, like the third embodiment, the diagnosis circuit 36 can output the diagnosis signal to the engine ECU 17 through the diag output terminal DI. Thus, the fourth embodiment can have a similar effect to that of the third embodiment.

### Fifth Embodiment

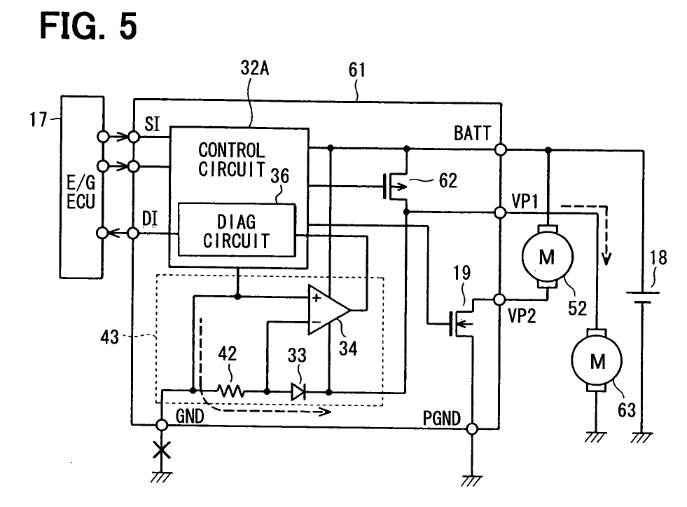

FIG. 5 illustrates a load driver 61 according to a fifth embodiment of the present invention. The load driver 61 employs both the high-side drive configuration of the second embodiment and the low-side drive configuration of the third embodiment. In the load driver 61, the output terminal VP of the third embodiment is considered as an output terminal VP2, and the motor 52 is coupled between a power terminal BATT and the output terminal VP2. A P-channel MOSFET 62 is coupled between the power terminal BATT and an output terminal VP1. Another motor 63 is coupled between the output terminal VP1 and a ground (first reference potential point).

Further, in the load driver 61, the anode of the diode 33 and the ground terminal of the comparator 34 are coupled to the output terminal VP1. Like the second embodiment, when the break occurs in the ground wire connecting the ground terminal GND to the chassis earth E, the diagnosis circuit 36 of a control circuit 32A can output the diagnosis signal to the engine ECU 17 through the diag output terminal DI. Thus, the fifth embodiment can have a similar effect to that of the second embodiment.

(Modifications)

The embodiments described above can be modified in various ways. For example, in the first and second embodiments, the wire break detection circuits 37, 43 can be provided to the output terminal VV side in addition to or instead of the output terminal VP side. A differential amplifier can be used as a wire break detection device instead of the comparator 34.

The reference potential can be a value other than zero volts. In the second, third, fourth, and fifth embodiments, the wire break can be detected without the diode 33 by ignoring the reverse current flowing from the control transistor (e.g., MOSFET 19) side to the ground terminal GND side. The wire break detection circuit 37 of the first embodiment can be applied to each of the third, fourth, and fifth embodiments. The present invention can be applied to various types of load drivers that drive an electric load by a direct current using a transistor.

Such changes and modifications are to be understood as being within the scope of the present invention as defined by the appended claims.

What is claimed is:

1. A load driver for driving an electric load comprising:
a transistor coupled in series with the load between a power source and a first reference potential point;
a control circuit configured to turn on and off the transistor to control a first electric current that flows in a path between the power source and the first reference potential point through the load, the control circuit being coupled through a wire to a second reference potential point that provides a reference potential to the control circuit; and
a wire break detection circuit including a current detection device that is coupled between a first point in the wire and a second point in the path to detect a second electric current flowing from the first point to the second point, the wire break detection circuit further including a wire break detection device configured to determine that a break occurs in the wire when the current detection device detects the second electric current,
wherein the control circuit and the second reference point are joined together at the first point, and
wherein the second point is located on the first reference potential point side with respect to the transistor.

2. The load driver according to claim 1,
wherein the current detection device includes a diode.

3. The load driver according to claim 1,
wherein the wire break detection device includes a comparator configured to detect a voltage drop across the current detection device.

4. The load driver according to claim 1,
wherein the transistor is coupled between the power source and the load in a high-side drive configuration.

5. The load driver according to claim 1,
wherein the transistor is coupled between the load and the first reference potential point in a low-side drive configuration.

6. The load driver according to claim 1,
wherein the transistor comprises four transistor elements coupled together to form a H-bridge circuit.
